(19) United States
(12) Patent Application Publication
(10) Pub. No.: US 2022/0314367 A1
(43) Pub. Date: Oct. 6, 2022

(54) METAL FOIL WELDING METHOD

(71) Applicant: FURUKAWA ELECTRIC CO., LTD., Tokyo (JP)

(72) Inventors: Nobuyasu MATSUMOTO, Tokyo (JP); Masamitsu KANEKO, Tokyo (JP); Fumika NISHINO, Tokyo (JP); Kazuyuki UMENO, Tokyo (JP); Daeyoul YOON, Tokyo (JP)

(73) Assignee: FURUKAWA ELECTRIC CO., LTD., Tokyo (JP)

(21) Appl. No.: 17/842,879

(22) Filed: Jun. 17, 2022

Related U.S. Application Data
(63) Continuation of application No. PCT/JP2020/049018, filed on Dec. 25, 2020.

(30) Foreign Application Priority Data
Dec. 25, 2019 (JP) 2019-234597

(51) Int. Cl. B23K 26/244

(52) U.S. Cl. CPC B23K 26/244; B23K 2103/12

(57) ABSTRACT

A metal foil welding method includes: a first step of stacking a plurality of metal foils; and a second step of welding the plurality of stacked metal foils by irradiating the plurality of metal foils with laser light having a wavelength of 400 nm or more and 500 nm or less.

This application is a continuation of International Application No. PCT/JP2020/049018, filed on Dec. 25, 2020 which claims the benefit of priority of the prior Japanese Patent Application No. 2019-234597, filed on Dec. 25, 2019, the entire contents of which are incorporated herein by reference.

### BACKGROUND

The present disclosure relates to a metal foil welding method.

In the related art, as a metal foil welding method, a technique for suppressing sputtering and blow holes by using a special jig (for example, JP 2016-30280 A), a technique for suppressing blow holes by combining a plurality of beams (for example, JP 2015-217422 A), and the like are known.

### SUMMARY

In the metal foil welding method as in JP 2016-0280 A and JP 2015-217422 A, there is a possibility that the labor and cost of welding increase.

There is a need for a metal foil welding method capable of reducing labor and cost.

According to one aspect of the present disclosure, there is provided a metal foil welding method including: a first step of stacking a plurality of metal foils; and a second step of welding the plurality of stacked metal foils by irradiating the plurality of metal foils with laser light having a wavelength of 400 nm or more and 500 nm or less.

### BRIEF DESCRIPTION OF THE DRAWINGS

FIG. 1 is a flowchart illustrating a metal foil welding method according to an embodiment;

FIG. 2 is an exemplary schematic view of the metal foils welding system according to the embodiment;

FIG. 3 is a graph illustrating an absorption rate of light of each metal material with respect to a wavelength of laser light to be emitted;

FIG. 4 is an exemplary schematic view illustrating a state of a laser light and a cross section of a corresponding molten state of a workpiece in the metal foil welding method according to the embodiment;

FIG. 5 is an exemplary schematic view illustrating a state of a laser light and a cross section of a corresponding molten state of a workpiece in the metal foil welding method according to the comparative example;

FIG. 6 is an exemplary graph showing a relationship between a relative speed between an optical head and a plurality of stacked metal foils, a power density of laser light, and a welding state in the metal foil welding method according to the embodiment;

FIG. 7 is an exemplary view illustrating a relationship between a welding condition index and a welding state in the metal foil welding method according to the embodiment;

FIG. 8 is a photograph showing a front face of a plurality of metal foils welded in a state of being stacked by the metal foil welding method according to the embodiment;

FIG. 9 is a photograph showing a back face of a plurality of metal foils welded in a state of being stacked by the metal foil welding method according to the embodiment; and

FIG. 10 is a photograph showing a cross section of a welded portion of a plurality of metal foils welded in a stacked state by the metal foil welding method according to the embodiment.

### DETAILED DESCRIPTION

Hereinafter, exemplary embodiments and modifications are disclosed. Configurations of the embodiments and the modifications described below, and functions and results (effects) provided by the configurations are examples. The present disclosure may be realized by configurations other than those disclosed in the following embodiments and modifications. In addition, according to the present disclosure, it is possible to obtain at least one of various effects (including derivative effects) obtained by the configuration.

Embodiments and modifications described below have similar configurations. Therefore, according to the configurations of the respective embodiments and modifications, similar functions and effects based on the similar configurations may be obtained. In addition, in the following description, similar reference numerals are given to similar configurations, and redundant description may be omitted.

In the present specification, ordinal numbers are given for convenience in order to distinguish components, parts, steps, and the like, and do not indicate priority or order.

In each drawing, the X direction is represented by an arrow X, the Y direction is represented by an arrow Y, and the Z direction is represented by an arrow Z. The X direction, the Y direction, and the Z direction intersect each other and are orthogonal to each other. Note that the X direction may also be referred to as a longitudinal direction, a relative movement direction, or a sweep direction, the Y direction may also be referred to as a short direction or a width direction, and the Z direction may also be referred to as a thickness direction or a direction perpendicular to a front face (irradiated surface).

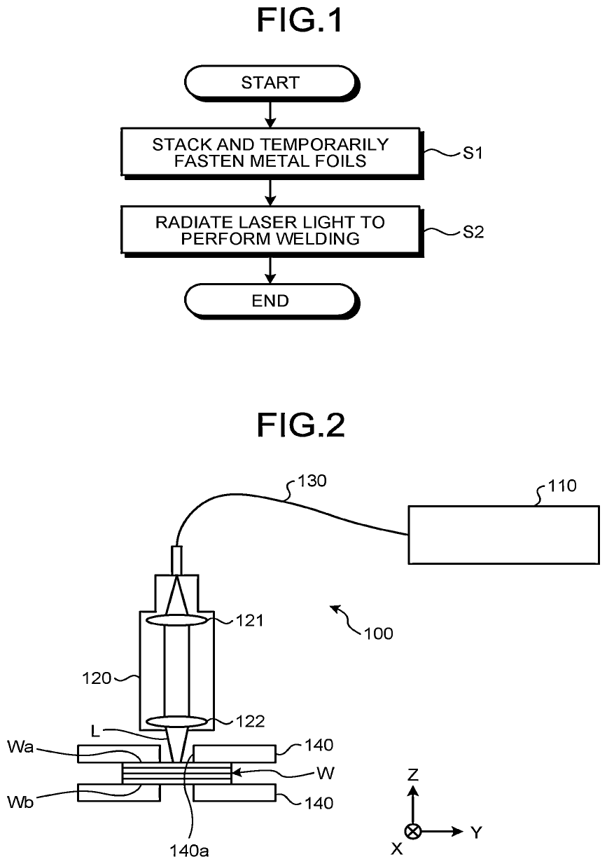

FIG. 1 is a flowchart illustrating a metal foil welding method according to an embodiment. FIG. 2 is a schematic view of a metal foil welding system 100.

As illustrated in FIG. 1, in the present embodiment, first, a plurality of metal foils is stacked and temporarily fastened (S1, first step), and then the plurality of metal foils is welded by irradiating the plurality of metal foils temporarily fastened in the stacked state with the laser light L (S2, second step). Hereinafter, the plurality of stacked metal foils is simply referred to as a workpiece W.

As illustrated in FIG. 2, in the workpiece W, the metal foils are each thin in the Z direction, extend in the X direction and the Y direction, and are stacked in the Z direction. In the present embodiment, two holding members 140 hold the workpiece W while sandwiching the workpiece W from both sides in the Z direction. The holding member 140 may also be referred to as a fixing jig or a fixing device.

The metal foil is, for example, an electrode plate of a secondary battery such as a laminated lithium ion battery, and the welded workpiece W is current collecting foils of a positive electrode or a negative electrode of the battery. In this case, the thickness of the metal foil is about 2 to 20 [μm], and the thickness of the workpiece W is, for example, about 0.2 [mm].

The holding member 140 is provided with an opening 140a. A front face Wa of the workpiece h is exposed from the opening 140a. The opening 140a has a slit shape extending in the X direction, in other words, an elongated rectangular shape, or a belt shape. Here, the front face Wa of the workpiece W faces an optical head 120 via the opening 140a. A back face Wb is a face opposite to the front face Wa and away from the optical head 120.

As illustrated in FIG. 2, a welding system 100 includes a laser device 110, the optical head 120, an optical fiber 130 connecting the laser device 110 and the optical head 120, and a holding member 140. The workpiece W is formed by stacking a plurality of metal foils. The thickness of each metal foil is, for example, 2 to 20 [μm], but is not particularly limited. The number of metal foils is, for example, 10 to 100, but is not particularly limited. The metal foil includes copper and aluminum, but the material of the metal foil is not particularly limited.

The laser device 110 is configured to be capable of outputting, for example, a laser light having a power of several kW. For example, the laser device 110 may include a plurality of semiconductor laser elements inside, and may be configured to be able to output multi-mode laser light having a power of several kW as the total output of the plurality of semiconductor laser elements. Further, the laser device 110 may include various laser light sources such as a fiber laser, a YAG laser, and a disk laser.

The optical fiber 130 guides the laser light output from the laser device 110 and inputs the laser light to the optical head 120.

It is preferable that the holding member 140 may fix the workpiece W such that there is no gap between two metal foils adjacent to each other as much as possible.

The optical head 120 is an optical device that emits the laser light L input from the laser device 110 via the optical fiber 130 toward the workpiece W. The optical head 120 is an example of an emission unit.

The optical head 120 includes a collimator lens 121 and a condensing lens 122. The collimator lens 121 is an optical system that converts the input laser light into collimated light. The condensing lens 122 is an optical system for condensing collimated laser light and irradiating the workpiece W with the laser light L. The optical head 120 emits the laser light L in a direction opposite to the Z direction. The laser light L passes through the opening 140a of the holding member 140 and is radiated to the front face Wa of the workpiece W. The front face Wa may also be referred to as an irradiated surface.

The welding system 100 is configured to be able to change a relative position between the optical head 120 and the workpiece W, that is, the holding member 140 holding the workpiece W. As a result, the radiation position of the laser light L moves on the front face Wa of the workpiece W. As a result, the laser light L sweeps on the front face Wa.

The relative movement between the optical head 120 and the workpiece W may be realized by a movement mechanism (not illustrated) that moves the optical head 120 alone, the workpiece W (holding member 140) alone, or both the optical head 120 and the workpiece W. In the present embodiment, the optical head 120 and the workpiece W relatively move in the direction in which the slit-shaped. opening 140a extends, that is, in the X direction.

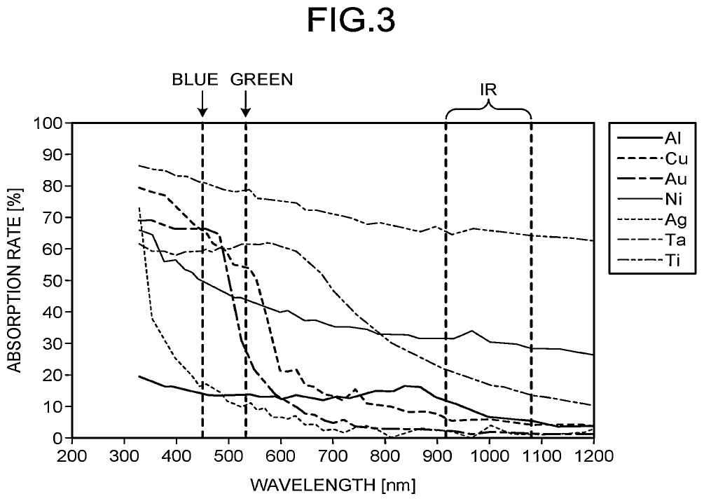

Here, the light absorption rate of the metal material will be described. FIG. 3 is a graph illustrating the light absorption rate of each metal material with respect to the wavelength of the laser light L to be radiated. In the graph of FIG. 3, the horizontal axis represents wavelength, and the vertical axis represents absorption rate. FIG. 3 illustrates the relationship between the wavelength and the absorption rate for aluminum (Al), copper (Cu), gold (Au), nickel (Ni), silver (Ag), tantalum (Ta), and titanium (Ti).

It may be understood that, for each metal illustrated in FIG. 3, the blue or green laser light L has a higher energy absorption rate than the general infrared (IR) laser light L, although the characteristics are different depending on the material. This characteristics are remarkable in copper (Cu), gold (Au), and the like.

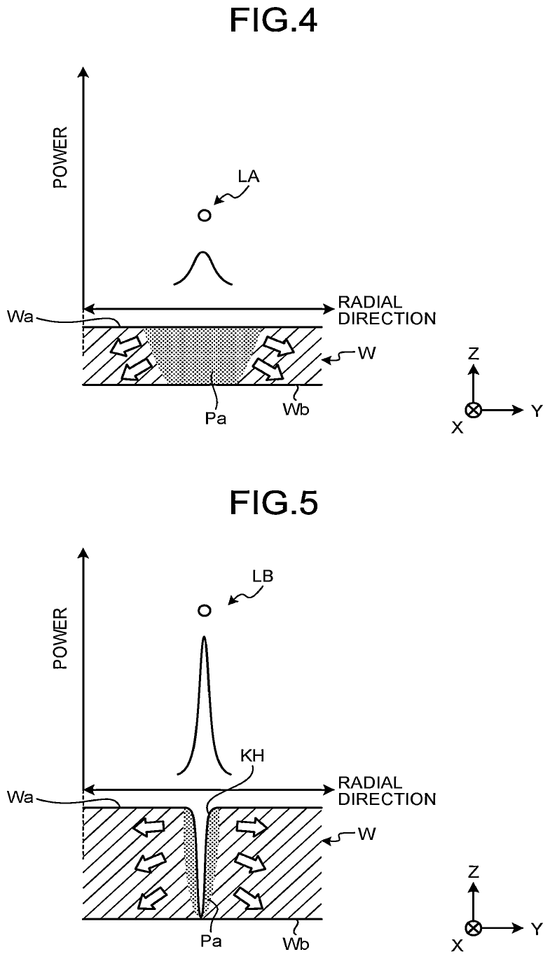

FIG. 4 illustrates a state (power distribution) of the laser light LA when the workpiece W having a relatively high absorption rate at the wavelength of the laser light LA is irradiated with the laser light LA and a cross section illustrating a molten state of the workpiece W corresponding thereto in the present embodiment. On the other hand, FIG. 5 illustrates a state (power distribution) of the laser light LB when the workpiece W having a low absorption rate at the wavelength of the laser light LB is irradiated with the laser light LB and a cross section illustrating a molten state of the workpiece W corresponding thereto in the comparative example.

As illustrated in FIG. 5, when the workpiece W having a relatively low absorption rate with respect to the used wavelength is irradiated with the laser light LB, most of the light energy is reflected and does not affect the workpiece as heat. Therefore, it is necessary to give relatively high power in order to obtain a molten region having a sufficient depth. In this case, energy is rapidly applied to the beam center portion, so that sublimation occurs and a keyhole KH is formed. Reference sign Pa indicates a molten region. In the molten state in which the keyhole KH and the molten region Pa are formed, there is a risk of leading to fusion cutting of the workpiece W when the workpiece W is a plurality of stacked metal foils.

On the other hand, as illustrated in FIG. 4, when the workpiece W having a relatively high absorption rate with respect to the used wavelength is irradiated with the laser light LA, most of the input energy is absorbed by the workpiece and converted into thermal energy. That is, since it is not necessary to give excessive power, it is not accompanied by formation of a keyhole, and thermal conductivity type melting is performed. In the case illustrated in FIG. 4, the molten region Pa is relatively wide, and a thermal conductivity type molten state is obtained.

Therefore, in the present embodiment, the laser light LA (L) having a suitable wavelength is selected for the workpiece W so that the welded portion has a relatively high absorption rate as illustrated in FIG. 4. The molten. region Pa in step S2 may be visually recognized as a welding mark on the front face Wa, the back face Wb, and the cross section of the workpiece W after being cooled and solidified. The molten region Pa may also be referred to as a weld metal or a welded portion.

It may be understood from FIG. 3 that when the workpiece W is copper (Cu), gold (Au), or the like, in other words, when the metal foil is a copper foil or a gold foil, specifically, the laser light L having a wavelength between 300 [nm] and 600 [nm] is preferably used, and the laser light L having a wavelength between 400 [nm] and 500 [nm] is more preferably used in the second step.

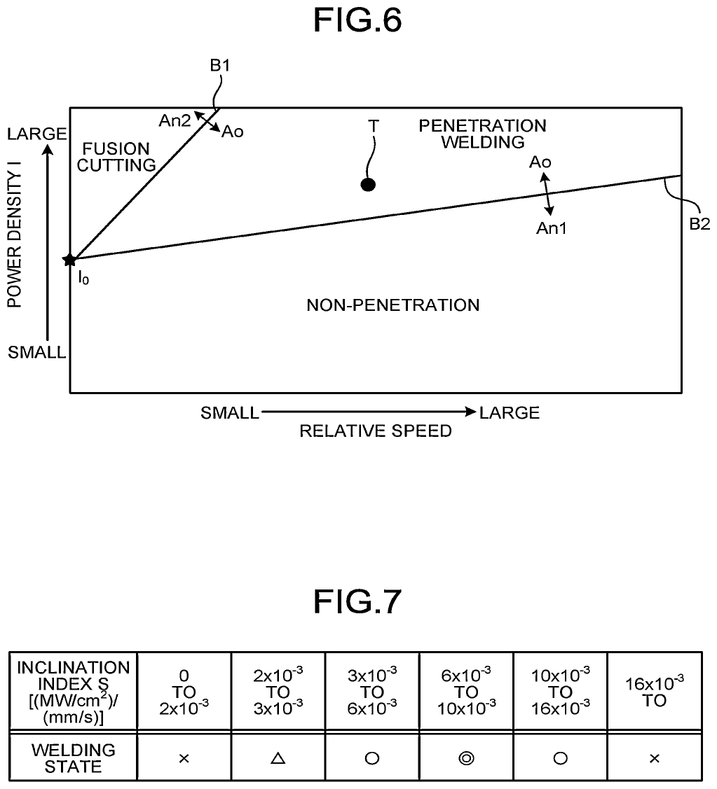

FIGS. 6 and 7 illustrate results of experiments performed under various conditions. FIG. 6 is a graph showing the relationship between the relative speed between the optical head 120 and the workpiece W, the power density of the emitted laser light L, and the welding state in the workpiece W. In FIG. 6, the unit of the power density is [MW/cm²], and the unit of the relative speed is [mm/s]. FIG. 7 is a diagram illustrating a relationship between a welding condition index E (described later) and a welding state in a workpiece W. Here, the power density is a value obtained by dividing the power of the laser light L by the spot area of the laser light on the front face Wa of the workpiece W. Hereinafter, the relative speed between the optical head 120 and the workpiece W is simply referred to as a relative speed, and the power density of the emitted laser light L is simply referred to as a power density.

In the experiments of FIGS. 6 and 7, blue laser light having a wavelength of 450 [nm] is used as the laser light L. The range of power to be output was changed at 100 to 500 [W], and the range of relative speed was changed at 1 to 80 [mm/s]. The workpiece W is a copper plate, and the thickness of the copper plate is 0.2 [mm]. The experiments in FIGS. 6 and 7 were performed on a copper plate, and it has been confirmed that when the thickness is the same under some conditions, a plurality of copper foils stacked in a close contact state and a copper plate have substantially the same results.

In FIGS. 6 and 7, “fusion cutting” refers to a case where the irradiated laser light L passes through the workpiece W and the hole is formed by the laser light L and the workpiece W is cut. “Penetration welding” indicates a case where the molten region Pa by the laser light L penetrates between the front face Wa and the back face Wb of the workpiece W and no hole is formed. “Partial penetration” refers to a state in which the molten region Pa by the laser light L partially penetrates between the front face Wa and the back face Wb of the workpiece W in the sweep section, and indicates a state in which the welding state of the plurality of metal foils is incomplete. In addition, “non-penetration” indicates a state in which the molten region Pa by the laser light L does not reach the back face Wb from the front face Wa of the workpiece W. Since the workpiece W is a plurality of stacked metal foils, “penetration welding” is a desired state, “partial penetration” and “non-penetration” are states where welding is incomplete, and “fusion cutting” is a state where welding is defective.

As a result of intensive studies based on experimental results, the inventors have found that, in the graph of FIG. 6, (1) the non-penetration and partial penetration region An1 (first non-permissible region) and the penetration welding region Ao (good region) may be separated by the boundary line B2 of a linear function, (2) the fusion cutting region An2 (second non-permissible region) and the penetration welding region Ao (good region) may be separated by the boundary line B1 of a linear function, and (3) the boundary line B1 and the boundary line B2 pass through a common intercept I₀ in the vertical axis of FIG. 6. The value of the intercept I₀ is, for example, about 0.32 [MW/cm²].

Therefore, the inclinations of the boundary lines B1 and B2 in FIG. 6, that is, the ratio of the increment of the power density to the increment of the relative speed, in other words, the differential value of the power density with the relative speed is referred to as an “inclination index (S)”, and it has become clear that the range of the region Ao may be set by the magnitude (Smin<S<Smax) of the inclination index S. In FIG. 6, the boundary line B2 corresponds to Smin, and Smin is about 2×10⁻³ [(MW/cm²)/(mm/s)]. The boundary line B1 corresponds to Smax, and Smax is about 16×10⁻³ [(MW/cm²)/(mm/s)]. In FIG. 6, the coordinates of a data point T indicated by a black circle in the region Ao and indicating the condition under which the experiment was performed are (40, 0.5).

In FIG. 7, the inclination index S of 0 or more and less than 2×10⁻³ indicates non-penetration, and is represented by a symbol “×”. The inclination index S of 2×10⁻³ or more and less than 3×10⁻³ indicates a partial penetration, and is represented by a symbol “Δ”. The inclination index S of 3×10⁻³ or more and less than 6×10⁻³ indicates penetration welding, and is represented by a symbol “o”. When the inclination index S is 6×10⁻³ or more and less than 10×10⁻³, the welding state is particularly good in the penetration welding, and is represented by a symbol “⊚”. The inclination index S of 10×10⁻³ or more and less than 16×10⁻³ indicates penetration welding, and is represented by a symbol “o”. The inclination index S of 16×10⁻³ or more indicates fusion cutting and is represented by a symbol “x”.

The setting of the range of the inclination index S based on FIGS. 6 and 7 described above is equivalent to the setting of the range of the welding condition index E in the following expression (1). That is, the inventors have found that

E=(P−P₀)/v·d (1)

where P is the power of the laser light by the laser device 110, P₀ is the minimum value of the power of the laser light L penetrating through the plurality of stacked metal foils (workpiece W) in a state where the plurality of stacked metal foils and the optical head 120 (emission unit) are relatively stationary, v is the relative moving speed (relative speed) between the plurality of stacked metal foils and the optical head 120, and d is the spot diameter (diameter) on the front face Wa of the laser light L, it has been confirmed that when the welding in step S2 is performed under the welding condition that the welding condition index E is equal to or more than the lower limit value Emin and less than the upper limit value Emax, the penetration welding, that is, the region Ao, is obtained. Here, the lower limit value Emin is a constant (constant value) when a welding mark appears in a minute size on the back face Wb of the plurality of stacked metal foils (workpiece W). The upper limit value Emax is a constant (constant value) when the laser light L passes through the plurality of stacked metal foils (workpiece W) to form a hole. The power P of the laser light is a value obtained by multiplying the power density by the area of the spot. Therefore, the welding condition index E corresponds to the inclination index S, that is, the inclination of the graph of FIG. 6. In other words, the welding condition index E is a function of the inclination index S. The minimum value P₀ corresponds to the intercept I₀. The minimum value P₀ (intercept I₀) varies depending on environmental conditions and physical properties of the workpiece W.

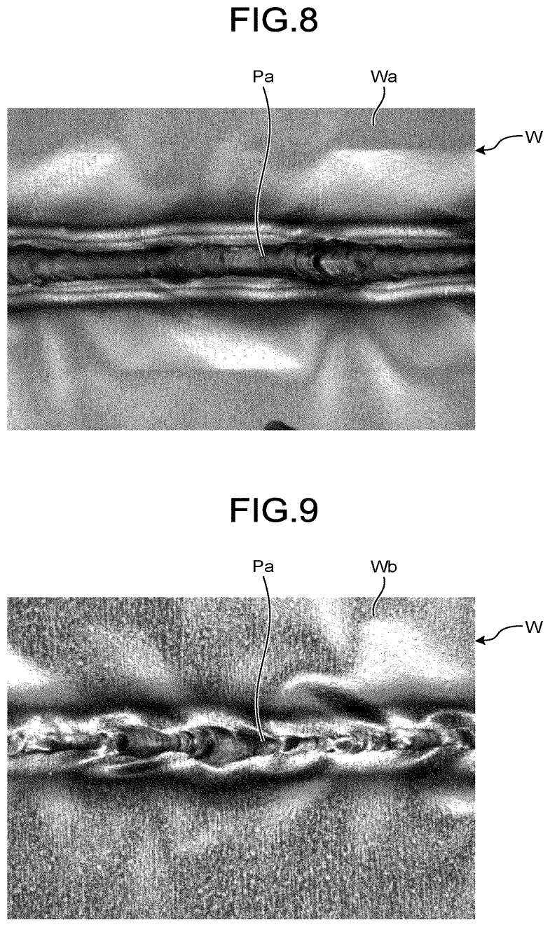

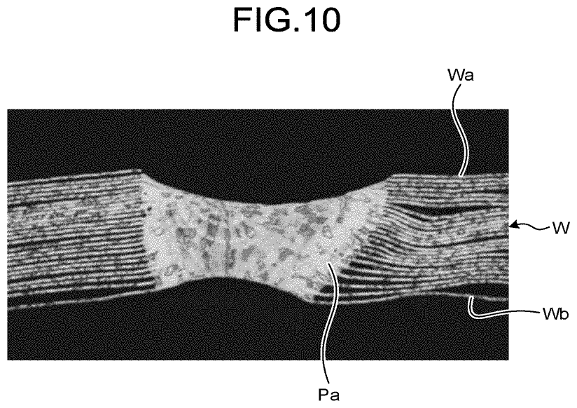

FIG. 8 is a photograph showing the front face Wa of a plurality of metal foils (workpiece W) welded in a state of being stacked by the metal foil weldinq method according to the embodiment, FIG. 9 is a photograph showing the back face Wb of the plurality of metal foils in FIG. 8, and FIG. 10 is a photograph showing a cross section of a welded portion (molten region Pa) of the plurality of metal foils. As shown in FIGS. 8 to 10, according to the present embodiment, it is possible to realize good stack welding without holes or breaks in the front face Wa and the back face Wb.

As described above, in the present embodiment, the metal foil welding method includes the first step (S1) of stacking a plurality of metal foils, and the second step (S2) of welding the plurality of stacked metal foils (workpiece W) by irradiating the plurality of metal foils with laser light L having a wavelength of 400 [nm] or more and 500 [nm] or less.

According to such a method, for example, thermal conduction type welding may be executed by appropriately setting the wavelength of the laser light L to be radiated, so that a good welding state without holes or breaks may be obtained. In addition, as compared with the conventional method, labor and cost required for welding the plurality of metal foils may be suppressed.

In the present embodiment, the metal foil is a copper foil.

The effect that a good welding state may be obtained by performing welding by irradiating the workpiece W with the laser light L having a wavelength of 400 [nm] or more and 500 [nm] or less is more remarkable when the workpiece W is copper, that is, when the metal foil is a copper foil.

In the present embodiment, in step S2 (second step), the plurality of stacked metal foils (workpiece W) and the optical head 120 (emission unit) that emits the laser light L are moved relative to each other to form a linear welded portion (molten region Pa). In this specification, the linear welded portion includes a straight-line welded portion, a curved-line welded portion and the likes.

The effect that a good welding state may be obtained by radiating the laser light L having a wavelength of 400 [nm] or more and 500 [nm] or less to perform welding may be obtained in a case where the plurality of stacked metal foils (workpiece W) and the optical head 120 (emission unit) emitting the laser light L are relatively moved to form the linear molten region Pa.

In the present embodiment,

when the welding condition index E is expressed by the following expression (1),

E=(P−P₀)/v·d (1)

in step S2, welding is performed under a welding condition that he welding condition index E is equal to or larger than a lower limit value Emin at which a welding mark appears on the back face Wb, of the workpiece W, away from the optical head 120 and is smaller than an upper limit value Emax at which the laser light L passes through the workpiece W to form a hole.

According to such a method, for example, a good welding state may be obtained by setting each condition so as to satisfy the expression (1). That is, for example, it is possible to more quickly or more easily set or change each condition so as to obtain a good welding state in step S2.

Although the embodiments have been exemplified above, the above embodiments are merely examples, and are not intended to limit the scope of the disclosure. The above-described embodiments may be implemented in various other forms, and various omissions, substitutions, combinations, and changes may be made without departing from the gist of the disclosure. In addition, specifications (structure, type, direction, model, size, length, width, thickness, height, number, arrangement, position, material, and the like) of each configuration, shape, and the like may be appropriately changed and implemented.

For example, the plurality of metal foils is not limited to copper foils. The plurality of metal foils welded in a stacking state may also be applied to other than the electrode, of the battery.

When the laser light sweeps on the workpiece, the surface area of the molten pool may be adjusted by performing sweeping by known wobbling, weaving, output modulation, or the like.

In addition, the workpiece may have a thin layer of another metal on the surface of the metal, such as a plated metal plate.

According to the present disclosure, for example, it is possible to obtain a metal foil welding method capable of reducing labor and cost.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A metal foil welding method comprising:
a first step of stacking a plurality of metal foils; and
a second step of welding the plurality of stacked metal foils by irradiating the plurality of metal foils with laser light having a wavelength of 400 nm or more and 500 nm or less.

2. The metal foil welding method according to claim 1, wherein the metal foil is a copper foil.

3. The metal foil welding method according to claim 1, wherein the second step includes relatively moving the plurality of stacked metal foils and an emission unit of a laser device configured to emit the laser light to form a linear welded portion.

4. The metal foil welding method according to claim 3, wherein
when a welding condition index E is expressed by the following expression (1),
E=(P−P₀)/v·d (1)
where P is power of laser light by the laser device, P₀ is a minimum value of power of the laser light passing through the plurality of stacked metal foils in a state where the plurality of stacked metal foil and the emission unit are relatively stationary, v is a relative moving speed between the plurality of stacked metal foils and the emission unit, and d is a spot diameter of the laser light,
the second step includes performing welding under a welding condition in which the welding condition index E is equal to or more than a lower limit value at which a welding mark appears on a face, of the plurality of stacked metal foils, away from the emission unit, and is smaller than an upper limit value at which the laser light passes through the plurality of stacked metal foils to form a hole.

5. The metal foil welding method according to claim 3, wherein an inclination index as a differential value of a power density obtained by dividing power of laser light L by a spot area of laser light on a front face of a workpiece with a relative moving speed between the plurality of stacked metal foils and the emission unit is 3×10⁻³ or more and less than 16×10⁻³.

6. The metal foil welding method according to claim 5, wherein the inclination index is 6×10⁻³ or more and less than 10×10⁻³.
